(19) United States
(12) Patent Application Publication
(10) Pub. No.: US 2026/0348996 A1
(43) Pub. Date: Nov. 5, 2026

(54) CADENCE DEVIATOR FOR SPECIMEN CARRIERS AND METHOD FOR CADENCING SPECIMEN CARRIERS

(71) Applicant: Thermo Fisher Scientific Oy, Vantaa (FI)

(72) Inventor: Mikko Pulli, Vantaa (FI)

(21) Appl. No.: 19/483,780

(22) PCT Filed: May 10, 2024
(86) PCT No.: PCT/FI2024/050227

§ 371 Date: Nov. 12, 2025

(30) Foreign Application Priority Data
May 12, 2023 (FI) 20235548

(51) Int. Cl. G01N 35/04; B65G 47/71; B65G 47/84

(52) U.S. Cl. CPC G01N 35/04; B65G 47/71; B65G 47/846; G01N 2035/0467

(57) ABSTRACT

According to an example aspect of the present invention, there is provided a method for moving specimen carriers (5) on a cadence deviator, the deviator comprising a deviator disc (11) and at least one entry (15, 16, 17) to the deviator disc (11) and two exits (18, 19, 20) from it, the deviator disc (11) having at least one slot (13) for receiving a specimen carrier (5) from an entry (15, 16, 17) and expelling it to an exit (18, 19, 20), and a control logic (49). The method comprising the steps of rotating the deviator disc (11) at a continuous motion, reading RFID data of the identifying the specimen carrier (5) at before arrival of the specimen carrier (5) to the entry (15, 16, 179 and instructing the deviator control logic (49) on which slot (13) of the deviator disc (11) the specimen carrier (5) has been inserted. Further, the deviator control logic (49) is instructed on which exit (18, 19, 20) the specimen carrier (5) is expelled from the deviator disc (11) and providing the expelling of the specimen carrier (5) at the instructed exit (18, 19, 20) by determining when the slot (13) with the specimen carrier (5) enters the instructed exit (18, 19, 20) on basis of the angular position of the deviator disc (11).

### FIELD

The present invention relates to conveying devices in sample analysis systems and other types of automatic specimen handling systems in laboratory environments. The present invention particularly relates to guiding and cadence specimen carriers controllably between several entry and exit points.

### BACKGROUND

Clinical laboratories may be handling numerous patient specimens per day. Each specimen is unique and they must be tracked carefully during the entire process. To accomplish this many laboratories utilize automatic specimen transportation systems. The specimens are typically held in carriers, which are transported between analysis and other specimen handling stations by moving the carriers along conveyors running between the processing points. The specimens are typically contained in sample tubes of various sizes and the carriers must be able to hold the tubes securely in all conditions. The samples are typically in liquid form, such as blood or components of blood, but could also be at least partly solid. The tubes may or may not be capped during the process. The tubes are labeled with a unique identifier such as a barcode which can be machine read automatically by the system. In addition, the carriers typically contain data transmitting means to exchange information related to their cargo within the system. Alternatively, the carriers may have an identifier that is combined with the identifier of the sample transported by the carrier. The identifier is indicated to a control system that controls the routing of the carrier.

It is sometimes necessary for a carrier to change its direction of travel and therefore travel on a non-linear path. To accomplish this, carriers are placed on turning devices. Different types of turning devices may be used in different parts of the conveyor system depending on whether the carrier is guided to travel to another conveyor track, to a sample handling station or to an analyser after it has been turned by the turning device.

Cadence deviator (1) is a device to control flow of carriers (2) that are used to move sample tubes in an automation system. The carriers are moved by belt conveyors. Cadence deviators perform some of the actions of turning devices and function also as deviators for selectively guiding a carrier to one of several available positions. Some examples of turning devices and deviators can be found in US 2022/0196052, U.S. Pat. Nos. 6,374,989, 6,202,829, EP 2315039, EP 3196653, EP 3405794, EP 3196654 and EP 2455763.

### SUMMARY

The invention is defined by the features of the independent claims. Some specific embodiments are defined in the dependent claims.

According to a first aspect of the present invention, there is provided a method for moving specimen carriers on a cadence deviator comprising a deviator disc and at least one entry to the deviator disc and two exits from the deviator disc having at least one slot for receiving a specimen carrier from an entry and expelling it to an exit, and a control logic, comprising steps of
rotating the deviator disc at a continuous motion,
identifying the specimen carrier at or before the arrival of the carrier to the entry or when the specimen carrier is within the at least one slot of the deviator disc,
instructing the deviator control logic on which slot of the deviator disc the carrier has been inserted and to which exit the carrier is expelled from the deviator disc, and
providing the expelling of the carrier at the instructed exit by determining when the slot with the carrier enters the instructed exit on basis of the angular position of the deviator disc.

According to a second aspect of the present invention, there is provided a cadence deviator comprising a deviator disc and at least one entry and two exits to the deviator disc having at least one slot for receiving a specimen carrier from an entry and expelling it to an exit, and a control logic, wherein the deviator disc is connected to an actuator providing rotation of the deviator disc at constant motion, a detector for identifying the specimen carrier at or before arrival of the specimen carrier to the entry or in the at least one slot, and a mechanism for selectively controlling exit from at least one of the exits, the control logic being configured to determine on basis of the RFID data and angular position of the deviator disc the selective expelling of the carrier.

Further aspects of the invention include one or more following features that can be combined to provide various embodiments:
in the method, operating the mechanisms of the deviator entries and exits and the rotating speed of the deviator disc with a control logic and controlling the routing of the carriers by another control logic,
pushing a carrier from the deviator disc,
stopping the carriers before entering the deviator disc,
pushing a carrier to a slot in the deviator disc,
elevating the carrier when pushing to the deviator disc,
preventing exit of the carrier from the deviator disc at least at one exit,
providing at least three tracks to the deviator and from it forming three exits and three entries.

Considerable benefits may be gained with aid of the present concept.

In the known deviator discs with only one input port, one specimen carrier slot and constant rotation direction, the disc must rotate a full turn to receive a new carrier to the same slot. The only way to increase sample throughput, i.e. number of samples deviated per time, is to increase disc rotating speed, which may be harmful to the samples. The deviator disc of the invention may be rotated on a slower motion without reducing throughput because there can be several input slots and ports and the disc may thus deviate several samples per full turn.

Throughput per sample speed ratio is thus higher than in the previous solutions where speed correlated to the traveled distance, i.e. only way to increase throughput was to increase speed. In the current solution throughput is calculated from the number of slots and disc rotating speed. This allows increasing the throughput by adding slots while keeping the speed same. Lower rotation speed leads to lower lateral acceleration forces. Thus, the specimens may be processed quickly but gently. This, in turn, has a positive effect on the samples, which are protected against lateral acceleration forces.

Further, the selective nature of the deviator disc provides for efficiency as the specimen carrier may be routed flexibly. It follows that a single deviator disc may be used to serve several different conveyor lines, thus increasing output.

Thereby, by incorporating several slots into the deviator disc, the specimen carrier may be held on the deviator disc for a longer time. This increases the time available for the carrier and the controlling software to communicate with each other before the carrier is deviated to an exit port. This increases flexibility as it provides a further possibility to check the carrier or sample identity and even re-route the carrier during their travel on the deviator disc.

### BRIEF DESCRIPTION OF THE DRAWINGS

FIG. 1 illustrates a cadence deviator in accordance with at least some embodiments of the present invention in a test tube handling system;

FIGS. 2-5 are partial top views of the FIG. 1 showing the cadence deviator in different operation phases;

FIG. 6 is an enlarged detail view of the cadence deviator in FIG. 2 5;

FIGS. 7-8 are enlarged detail views of the cadence deviator in FIGS. 2-5; and

FIG. 9 illustrates an example cadence deviator supporting at least some embodiments of the present invention.

### EMBODIMENTS

### Definitions

A detector is considered as means for detecting, for example a shape, radiation, color or a pattern.

Identification means are any means for indicating one element from a group of otherwise similar elements.

In the present context, the term “test tube carrier” comprises any specimen carrier usable in an automated system.

The cadence deviator described herein provides a new way to control moving test tube carriers between several entry points and exit points. In large laboratory and analysing test centres test tubes are handled automatically in large quantities. There are many analysing and treating positions where individual samples may or may not be handled and test tubes are transferred between these positions by automatic transporting systems. The sequencing order and routing of the samples is determined by a control software. As each sample tube must be transferred to specific positions to perform analyses allocated to it, a guiding system is needed to feed the test tubes to correct positions. Belt conveyors transferring the test tube carriers usually perform transfer. The carriers run on the conveyors. The sample tubes are loaded or removed from the carriers when needed. Carriers may be routed to be transferred from one conveyor to another. The cadence deviator uses a disc having slots on its perimeter for receiving test tube carriers. The disc is rotated at a known speed. This means that the speed and rotating direction of the disc is constantly known either by detecting the speed and angle of rotation or by reading or controlling it using the drive of the actuator causing the rotation. Preferably the disc is run on continuous speed or at least continuous motion and its angle of rotation is detected. In this way the position of each slot is constantly known. Each test tube carrier is detected on entry to the disc and at least the exit of the carrier from the disc is controlled according to the detected data by letting the carrier exit at correct position when its slot enters that position according to detected angular position of the disc. By using multiple entry and exit points and entry and exit ports multiple routes and deviation alternatives can be obtained.

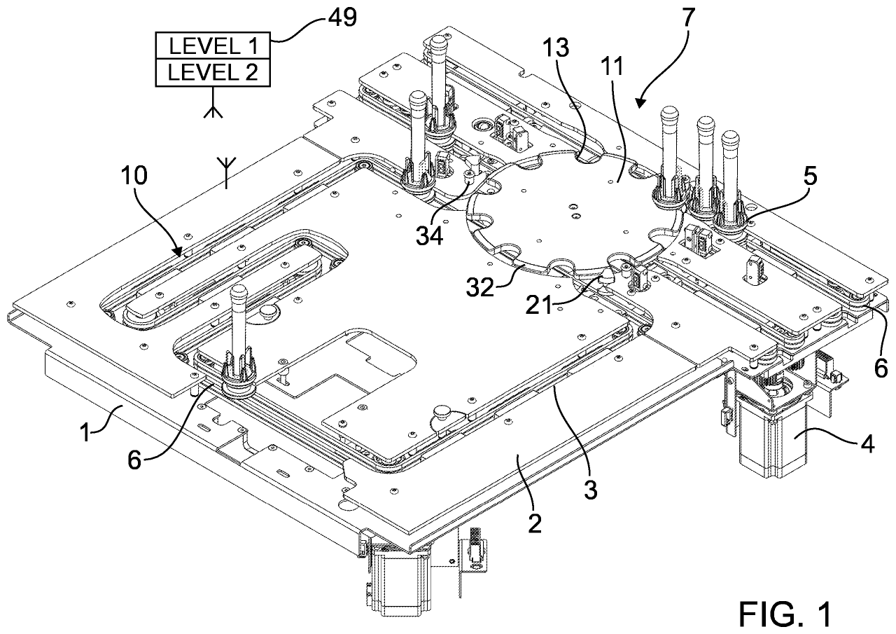

FIG. 1 illustrates a part of a test tube handling system comprising a cadence deviator 7. The system is built on a base 1 on which for example motors, other actuators, detectors and such are mounted either directly or using brackets, mounting plates and such. The base 1 carries a track plate 2 on which a travel routes i.e tracks 3 of the test tube carriers 5 (in following shortly carriers). Under the track plate 2 are belt conveyors in which the belts 6 are run on their sides to enable also curved pathways i.e. tracks 3. The tracks 3 are each made of separate belt conveyors in each of the modules along the automation system. An example of an automation module with tracks 3 and with a cadence deviator 7 is presented in FIG. 1. In this example, there are three tracks in the module: front track 8, back track 9 and module track 10. The module comprising the module track 10 is used herein to depict any element connected to the system, for example a route to an analyzer or a buffer track. Each of the tracks 8, 9, 10 has one entry 15, 16, 17 and one exit 18, 19, 20 ports to the deviator disc 11. There could be fewer ports, at least one entry and two exit ports as a minimum, or there could be more ports than that. The deviator disc 11 is capable of deviating any carrier 5 from any entry 15, 16, 17 to any exit 18, 19, 20. The operation of the system is controlled by control logic 49. The control logic may be implemented by one or more hardware logic operation systems and/or one or more layers of system software SW. Systems that are normally used on laboratory automation systems are suitable herein.

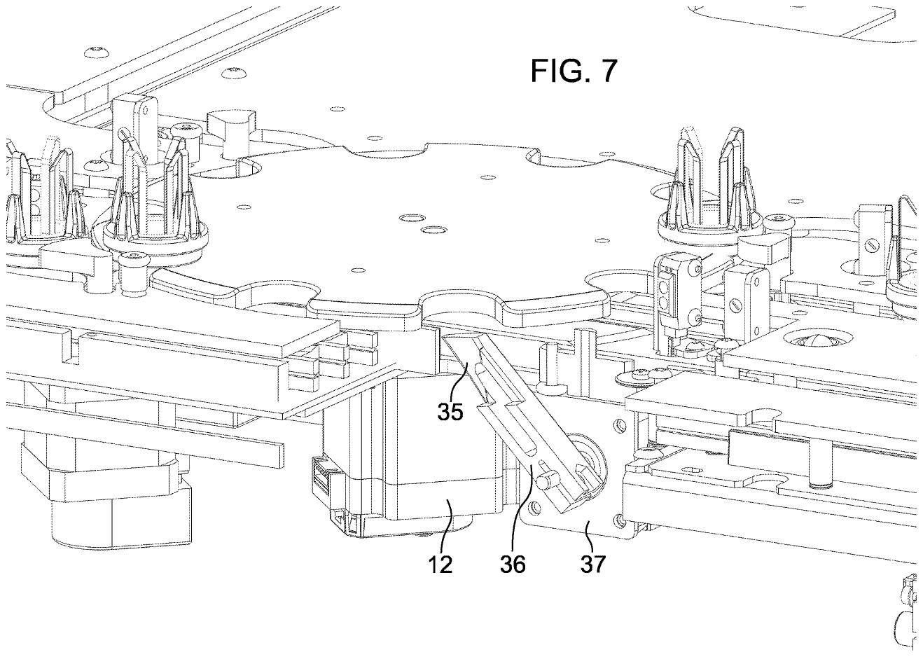

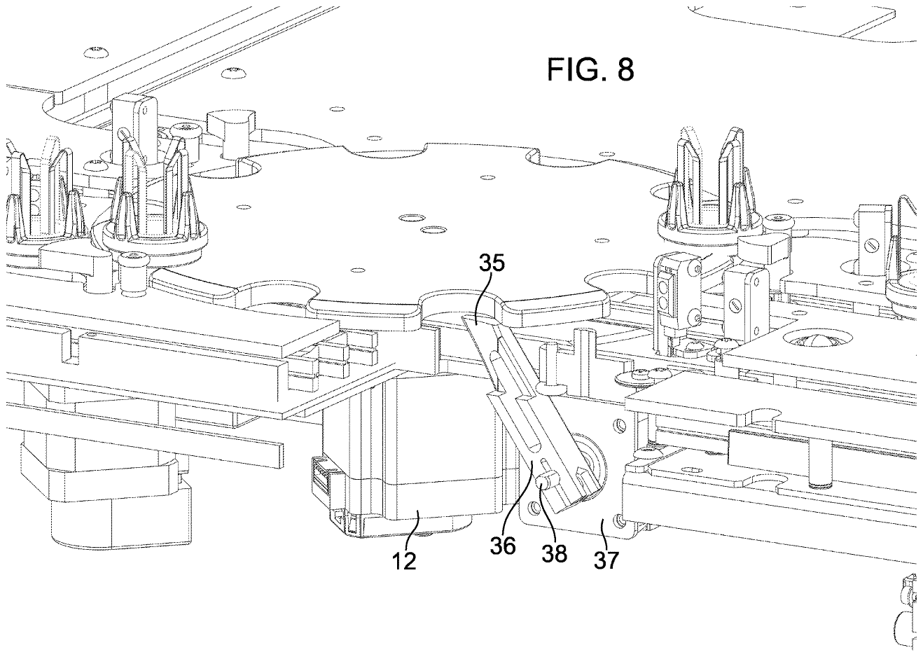

The deviator disc 11 is connected to a disc motor 12 (see FIGS. 7 and 8) used to provide rotation of the deviator disc 11. The disc motor 12 is a step motor or similar actuator being capable of indicating the rotation angle of the deviator disc 11. The rotation angle may be detected or indicated by an encoder or other indicator device. The deviator disc 11 has one or more slots 13 for the carriers 5; 10 slots in this example. The slots 13 are arranged on the perimeter of the deviator disc 11 on equiangular distances, i.e the angle formed from the disc axis 14 between adjacent slots 13 is the same. In this embodiment the disc is symmetrical, its circumference is a perfect round circle, the slots are located on a symmetrical circle on an equal distance from the disc center point. However, for example a non-symmetrical design with different variations can be contemplated.

The deviator is operable with having a deviator disc with one slot only. However, utilizing the full benefits of the construction, a disc with multiple slots is needed. A typical number of slots is 6-12. The preferred number of slots is dependent of number of entries and exits on the deviator disc. The preferred number of the slots is at least the total number of the entries and exits, most preferably greater than that, in minimum at least one more than the sum of the entries and exits. This provides high deviating and handling capacity of the deviator allowing high feeding and exit rate of the carriers.

The deviator disc 11 rotates around its own, vertical disc axis 14 and when rotating, transfers carriers 5 in the slots 13. By reading the rotation angle of the deviator disc 11 from a step motor or detecting the rotation angle, the location of each slot 13 is known at every moment. This feature is used for controllably feeding the carriers 5 into the deviator disc 11 and exciting them from it. Angles or distances on the perimeter between the slots may vary, which is be taken into account when their positions are calculated. Each entry has means, entry ports 21, to allow or prevent a carrier 5 to go into the deviator disc's slot 13. This way the entry port 21 can control which carrier 5 goes into which slot. 13. It is also possible not to have the means on entries in which case the carriers 5 just go to the next available slot 13 on the deviator disc 11. The deviator disc may be rotated at a constant speed or its speed may be decreased when a slot closes to an entry or an exit. Even rotation both clockwise and counter clockwise can be contemplated.

Respectively, there are means forming exit ports in each exit 18, 19, 20 to allow or prevent the carrier 5 to exit the deviator disc 11 and by those means the deviator 7 can control at which exit 18, 19, 20 each carrier 5 leaves the deviator disc 11. If there are no active means in exits, the exits can be set to always exit or always prevent exiting by static means.

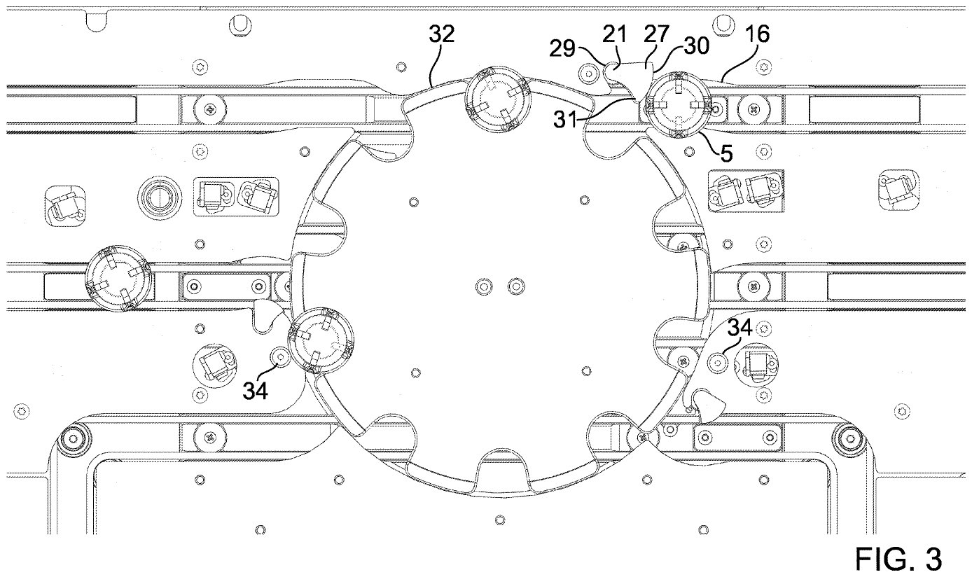

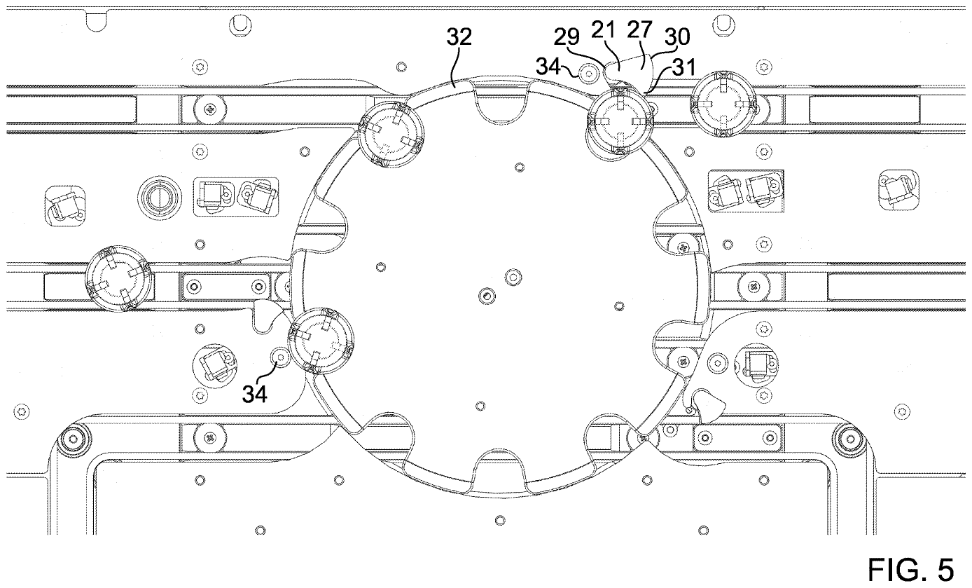

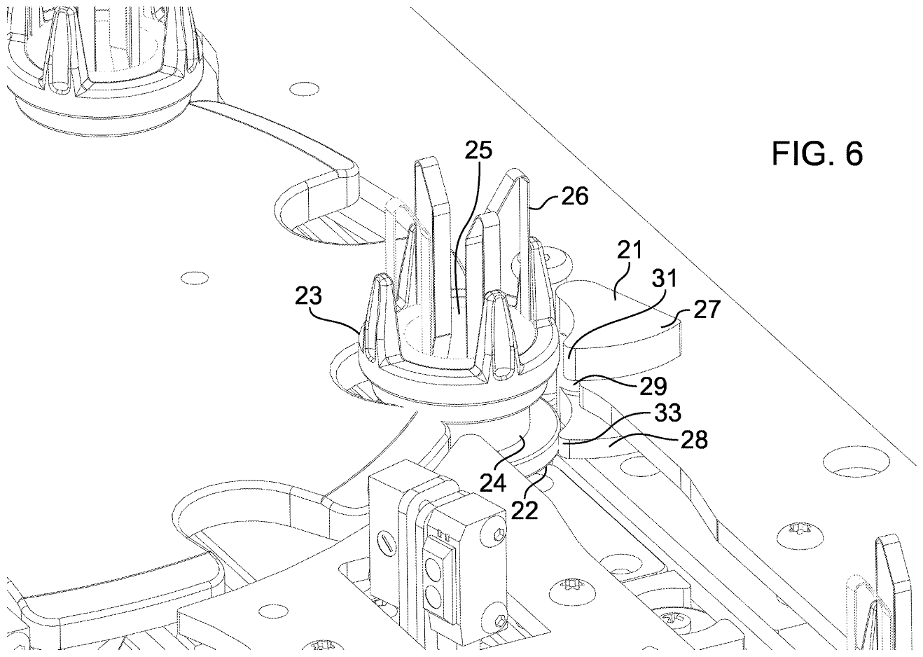

FIGS. 3-6 illustrate an example entry port 21. First, a short description of the carrier 5 used in the system is needed. The carrier 5 is a circular puck having a lower bumper disc 22 and an upper bumper disc 23. Between the bumper discs 22, 23 is a groove 24. On top surface of the carrier is a hole 25 for a test tube and support fingers 26 for holding the test tube upright. The structure and shape of the carrier 5 may vary, but a groove 24 between limiting surfaces is advantageous. The function of the groove is to set the carrier 5 on the track on the track plate 2. The lower bumper surface 22 is set below the track plate 2 and the upper bumper surface 23 is set above the track plate 2. The groove 24 is set between the edges of a track 8, 9, 10. The bottom of the carrier 5 travels on the belt conveyor and may be flat, for example. One alternative form of the carrier would be a cylindrical body having straight outer wall. This would allow lifting the cylindrical carrier away from the track, but it would still stay on the track if not lifted. However, the groove provides stability and prevents the carrier falling. A more comprehensive description of one example of a belt conveyor system applicable herein can be found in EP1106542.

The carriers 5 are moved in the system on belt conveyors along the tracks 8, 9, 10. In this example each entry 15, 16, 17 has a rotating entry port 21 for controlling the flow of carriers 5 from the entry 15, 16, 17 to the deviator disc 11. In one position the entry port prevents carriers 5 proceeding further and in other position it allows carriers 5 to pass the port and proceed to the disc. The rotating movement of the entry port 21 in this example is performed by a stepper motor but other type of motors or a rotating solenoid could also be used. A linear solenoid or a mechanism connected to the rotating deviator disc 11 could also be used. The entry port 21 comprises an upper nose 27 set above the track plate 2 and a lower nose 28 set below the track plate 2. The upper and lower nose 27, 28 are mounted on an axle support 29 connected to the stepper motor or another actuator, if such is more preferably used.

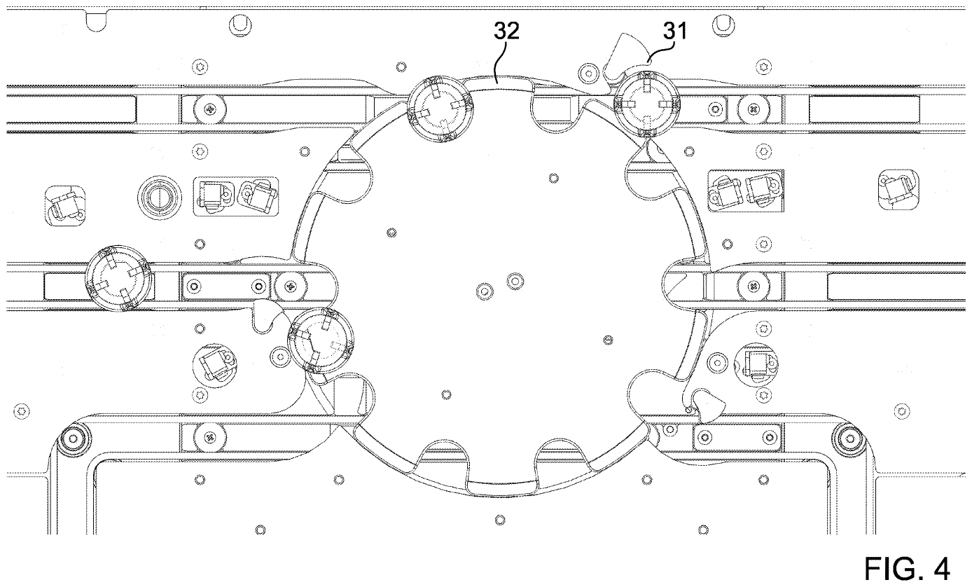

The action of the entry port 21 controls the entry to the deviator disc 11. In FIG. 3 the entry port 21 is depicted in a holding position, see back track entry 16 on the upper right corner of the FIG. 3. The upper nose 27 has a curved holding surface on the opposite end to the axle support 29. When turned partially over the entry 16 of the back track 9, it contacts a carrier 5 moving towards the back track entry 16 and is stopped by the holding surface 30 of the upper nose 27. When allowance to enter the deviator disc 11 (slot 13) is received, the entry port 21 turns away from the back track entry 16 and allows the carrier 5 to enter the slot 13. The belt conveyor (FIG. 4) effects the movement of the carrier 5.

The entry port 21 may include a pushing function to facilitate transfer of the carriers 5 to the deviator disc 11. For this purpose, the upper nose 27 may include an upper beak 31 at a distance from the axle support 29 and pointing towards the entry 16 of the back track 9.

The deviator disc 11 of this example has an optional feature to elevate carriers 5 above the belts 6 of the belt conveyor. The carriers 5 set on the slots 13 are located higher than when they are on the track belts 6. As the carriers are elevated on the deviator disc 11, their bottoms do not touch the belts 6 when they are being moved across the belts 6 along the rotating deviator disc 11. This feature reduces shaking of the samples in the carriers 5 while moving from an entry 15, 16, 17 to an exit 18, 19, 20 and is beneficial for the sample integrity. For example, if the samples are centrifuged, preventing shaking prevents re-mixing of the sample. As the forwarding action of the belts 6 cease when the carrier is lifted from the belt, a pushing force may be needed to facilitate placing the carrier into a slot 13. This is provided by rotating the entry port 21 towards the back track entry 16. The upper beak 31 pushes the carrier into the slot 13. The function to push the carriers 5 into the slots confirms and speeds up its transition onto the deviator disc 11. This will make the transits more consistent and reliable.

There can also be optional ramps 32 (see FIG. 1) on the deviator disc's 11 outer perimeter to enable smoother shifting for the carriers 5 from the belts 6 on to the deviator disc 11. The ramps 32 are provided as slanted surfaces made on the edge of the outer perimeter of the deviator disc 11 between the slots 13. The optional ramps 32 on the deviator disc's 11 outer perimeter enable smoother shifting for the carriers 5 from the belts 6 on to the deviator disc 11. Such ramps might be placed on top of the track plate 2 on the sides of the track or on the sides of the belts below the track plate. Such placement, however, may be more difficult to fit into the design and layout.

A further feature related to the lifting to the different elevation, the entry ports 21 have an optional feature of two noses, upper and lower nose 27, 28. The upper and lower nose 27, 28 are distanced from each other and located on opposite sides of the track plate 2 on the same axle support 29. The beak 33 of the lower nose 28 extends further in the direction of the entry 16 of the back track 9 than the upper beak 31. Now, when the entry port 21 is turned towards the entry 16 of the back track 9, the lower beak 33 contacts the carrier 5 first. This allows the carrier 5 to tilt a bit while being pushed. This makes it easier for the carrier 5 to slide upwards onto the deviator disc 11.

As the carriers 5 travel along with the rotating deviator disc 11, they may slowly slide away from the disc center. For this reason, there can be an optional feature, a static pusher 34, to confirm that the carriers 5 are properly on their slots 13. The pusher 34 is positioned so that if the carrier 5 is not properly in its slot 13 while passing the pusher 34, the carrier 5 collides with the pusher 34 while being moved pass it on the rotating deviator disc. The contact forces the carrier 5 deeper into its slot 13. In the example of the pictures, there is one pusher 34 for each entry 15, 16, 17, but the number of pushers 34 could be more or less than that.

In the above, only the entry port 21 at the entry 16 of the back track 9 has been discussed. The operation and construction of the entry ports 21 is the same at other entries.

In order to control the path of the carriers 5, a way to control where the carriers exit from the deviator disc 11 is needed. For the minimum number of choices at least one entry and two exits are needed. At least one of the exits preferably has a way either to allow or to deny the exit. Then, if both exits are open, the carriers exit from the first exit in the direction of the rotation until the first exit is full. Normally such situation is not allowed as it leads to jamming easily. By closing and opening the first exit in the direction of the rotation, carriers can be directed selectively to first or second exit. This principle is then multiplied to larger number of entries, exits and means to control the entry and exit.

In each exit port 18, 19, 20, there are guiding surfaces 35 that can be presented or absented on the path of carriers 5 on the deviator disc 11 (FIGS. 7 and 8). If exit port's 18, 19, 20 guiding surface 35 is presented, the carrier 5 on the deviator disc 11 will collide with the guiding surface 35. Consequently, the guiding surface 35 will force the carrier 5 out of the slot 13 of the deviator disc 11 to exit it from the deviator disc 11 at the exit port 18, 19, 20. If the guiding surface 35 is absented, the carrier 5 will not collide with the guiding surface 35 and hence the carrier 5 will stay on the deviator disc 11 and continue its travel on the deviator disc 11.

In this example, the guiding surface 35 is part of an exit port arm 36 and the exit port arm 36 is attached on an axis of a stepping motor 37. The stepping motor 37 is mounted on the base 1 by a bracket. Running the axis will change the position of the guiding surface 35 to make it either absent (in lower position, FIG. 7 or present (in upper position, FIG. 8. The guiding surfaces 35 could as well be moved by other means, like a dc-motor, a linear or rotary solenoid or it could be powered by the rotating deviator disc. The arm could also be driven by a mechanism rather than being directly on axis.

There could also be another surface on each exit port, one that would prevent carriers exiting the disc. This could be used together with the previous guiding surface to prevent unwanted exit, only one of them being presented at a time. It could also be used alone, for example if the carriers were not elevated off from the belt surface but would be on belts at least on the exit ports' areas. In that case, the exit would happen always when the preventive surface is absent. This preventive surface could be driven, just like the earlier guiding surface, by numerous different means.

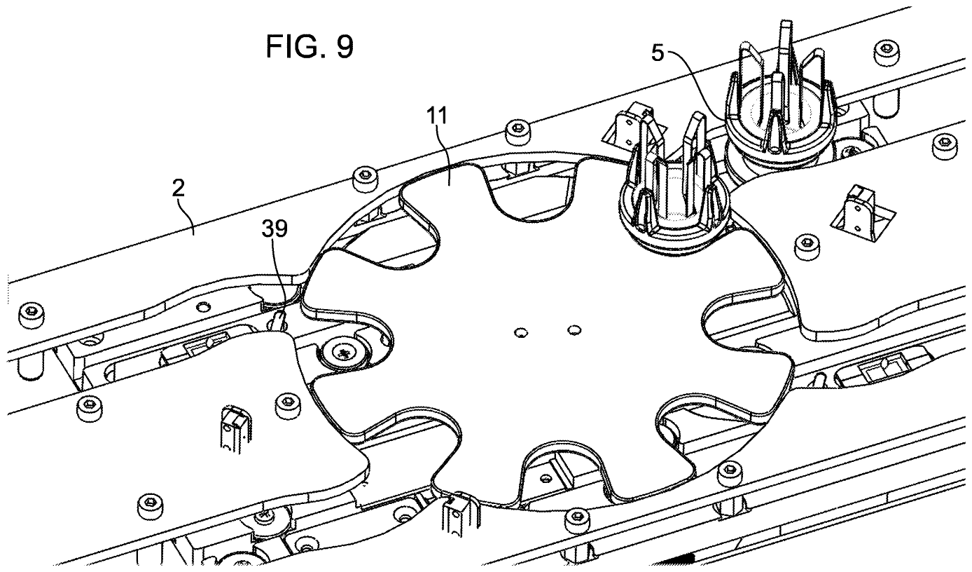

In addition, in some cases, it could be convenient to replace actively controlled surfaces with passive surfaces. For example, if the module is the last one in the automation system line, all the carriers would be guided to exit on the back track, never on the front track. In that case, the exit port to the front track could be equipped with passive surfaces to always prevent exit to the front track and the exit port to the back track could be equipped with passive surfaces to always allow exit to the back track. FIG. 9 illustrates the feature where the cadence deviator may include various numbers of entries and exits, in this example two entries and exits. This example also shows the preventive surfaces 39 at the exit ports.

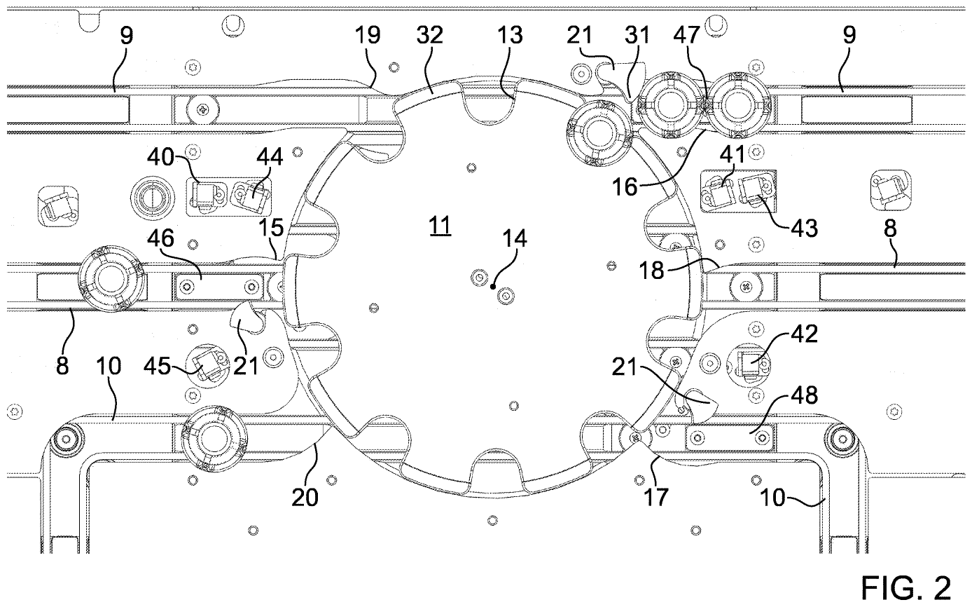

The operation of the deviator uses entry and exit sensors and RFID readers. Each carrier has an RFID chip or other information storage and/or exchange device that includes the carrier ID specific to the carrier. The sample ID is linked to the carrier ID only at the higher-level system software (SW). Carriers could also be identified, e.g. by 2D barcode or QR code at their bottom, by color or just by knowing the order by higher-level system software (carriers identified elsewhere, not at the deviator). Alternatively, the RFID includes data specific to the carrier routing and/or the handling of the sample carried on the carrier 5. This data, if provided, specifies where the carrier is guided on the deviator. Otherwise, the higher level SW commands the deviator into which exit the carrier is to be guided. An example setup is shown in FIG. 2. Each entry 15, 16, 17 has an entry RFID reader placed, in this case on the belt conveyor between the belts 6 in front of the entry 15, 16, 17. The RFID reader reads the data from the carrier RFID and sends the data to higher level SW which instructs the deviator's control logic where to guide the carrier or instructs a control logic where to guide the carrier. The control logic then instructs the deviator to allow exit of the carrier accordingly at a determined exit when the indicated rotation angle of the deviator disc 11 indicated that the slot carrying the carrier is at the determined exit. Each entry and exit has optionally a sensor to confirm presence, entry and exit of a carrier. One placement of the sensors 40-45 is depicted in FIG. 2. It can be contemplated that the identifying the specimen carrier takes place at least at one of the following locations: at the arrival of the carrier to the entry, before the arrival of the carrier to the entry or when the specimen carrier is within the at least one slot of the deviator disc.

There are multiple ways of creating control logic for this kind of deviator. The root of the logic is in knowing the position of the deviator disk to control the input and output of the carriers placed to this deviator. When the deviator disk is at certain position, it shall trigger the controlling of the specific entries and exits. The logic operating the entry or exit can then be run with a predefined sequence. Each exit and entry can have their own trigger deviator disk position. If the deviator disk is run at constant speed, the triggering points and operating speeds of the mechanism can be held constant making adjustment to varying speed unnecessary.

Higher level control logic controls the routing decision and does not have to be hard real time operation. Routing decisions are made individually for each carrier by the higher-level control logic and can be given as commands to the lower level control logic that moves the mechanisms at the exits and entries. This generates advantageous abstraction layers of the real time controlling and higher-level decision making. The lower level control can thus be also created in an embedded device and the higher-level logic in a PC environment. In here the control logic is understood to comprise any control device capable of performing the control acts.

Each motor controlling the deviator disk or the entries or exits may have feedback sensor (e.g. encoder) so the control logic can detect anomalies and confirm the unit operations (input and output) have actually been performed. The deviator may be operated without this feature but reliability may decrease.

With each exit and entry, it is possible to control the exact route of each carrier and control the flow of samples from any direction. Depending on higher level logic this allows to increase the flow from one entry port and restrict the flow from another.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The invention can be used in laboratory automation and providing handling systems for test tube carriers and other specimen carriers.

### REFERENCE SIGNS LIST

1 base
2 track plate
3 path
4 motor
5 carrier
6 belt
7 cadence deviator
8 front track
9 back track
10 module track
11 deviator disc
12 disc motor
13 slot
14 disc axis
15 entry, front track
16 entry, back track
17 entry, module track
18 exit, front track
19 exit, back track
20 exit, module track
21 entry port
22 lower bumper disc
23 upper bumper disc
24 groove
25 hole
26 support fingers
27 upper nose
28 lower nose
29 axle support
30 holding surface
31 upper beak
32 ramp
33 lower beak
34 static pusher
35 guiding surface
36 exit port arm
37 stepping motor
38 axis of the stepping motor
39 preventive surface
40 entry sensor front track
41 entry sensor back track
42 entry sensor module track
43 exit sensor front track
44 exit sensor back track
45 exit sensor module track
46 front track entry RFID reader
47 back track entry RFID reader
48 module track entry RFID reader
49 control logic

### CITATION LIST

### Patent Literature

US 2022/0196052, U.S. Pat. Nos. 6,374,989, 6,202,829, EP2315039, EP 3196653, EP 3405794, EP 3196654, EP 2455763.

1. A method for moving specimen carriers (5) on a cadence deviator, the deviator comprising a deviator disc (11) and at least one entry (15, 16, 17) to the deviator disc (11) and two exits (18, 19, 20) from it, the deviator disc (11) having at least one slot (13) for receiving a specimen carrier (5) from an entry (15, 16, 17) and expelling it to an exit (18, 19, 20), and a control logic (49), comprising the steps of:
rotating the deviator disc (11) at a known motion;
identifying the carrier (5) at least on one of the following locations: at the arrival of the specimen carrier (5) to the entry (15, 16, 17); before the arrival of the specimen carrier (5) to the entry (15, 16, 17); when the specimen carrier is within the at least one slot (13) of the deviator disc (11),
characterized by
instructing the deviator control logic (49) on which slot (13) of the deviator disc (11) the specimen carrier (5) has been inserted and to which exit (18, 19, 20) the specimen carrier (5) is expelled from the deviator disc (11), and
providing the expelling of the specimen carrier (5) at the instructed exit (18, 19, 20) by determining when the slot (13) with the specimen carrier (5) enters the instructed exit (18, 19, 20) on basis of the angular position of the deviator disc (11).

2. A method according to the claim 1, comprising operating the mechanisms of the deviator entries (15, 16, 17) and exits (18, 19, 20) and the rotating speed of the deviator disc (11) with a control logic (49) and controlling the routing of the carriers (5) by another control logic.

3. A method according to one of the claims 1 or 2, comprising pushing the carrier (5) from the deviator disc (11) at an exit (18, 19, 20).

4. A method according to one of the claims 1-3, comprising selectively stopping the carriers (5) at the entry (15, 16, 17) before entering the deviator disc (11).

5. A method according to one of the claims 1-4, comprising pushing a carrier (5) to the slot (13) in the deviator disc (11).

6. A method according to one of the claims 1-5 comprising elevating the carrier (5) when pushing it to the slot (13) in the deviator disc (11).

7. A method according to one of the claims 1-6, comprising preventing exit of the carrier (5) from the deviator disc (11) at least at one exit (17, 19, 20).

8. A method according to one of the claims 1-7, wherein carriers (5) are identified by at least one method from the group: RFID, 2D barcode or QR code at bottom, color or storing the data of the order of the specimen carriers (5) by system software when carriers (5) are identified away from the deviator.

9. A method according to one of the claims 1-8, wherein said instructing is performed, when the specimen carrier (5) is at the at least one slot (13) of the deviator disc (11).

10. A method according to one of the claims 1-9, wherein the deviator disc (11) comprises several slots (13).

11. A method according to the claim 10, wherein the deviator disc (11) comprises at least one more slot (13) than the sum of the entries (15, 16, 17) and exits (18, 19, 20) to the deviator disc (11).

12. A method according to one of the claims 1-11, wherein the deviator disc (11) is rotated on a continuous motion, preferably on a constant speed.

13. A cadence deviator comprising
a deviator disc (11) having at least one slot (13) for receiving a specimen carrier (5),
at least one entry (15, 16, 17) to and two exits (18, 19, 20) from the deviator disc (11),
a control logic (49),
an actuator providing rotation of the deviator disc (11) at known motion, and
a detector (40, 41, 42) for identifying the specimen carrier (5) at or before arrival of the specimen carrier (5) to the entry (15, 16, 17) or in the at least one slot (13), characterized by
a mechanism for selectively controlling exit from at least one of the exits (18, 19, 20),
wherein:
the deviator disc (11) is configured to receive a specimen carrier (5) from an entry (15, 16, 17) and to expel it to an exit (18, 19, 20), and
the control logic (49) is configured to determine on basis of the specimen carrier (5) identifying data and angular position of the deviator disc (11) the selective expelling of the carrier (5).

14. A cadence deviator according to the claim 13, comprising at an exit (15, 16, 17) a guiding surface (36) for guiding the specimen carrier (5) from the slot (13) to the exit (18, 19, 20).

15. A cadence deviator according to the claim 13 or 14, comprising an entry port (21) at an entry (15, 16, 17) for selectively stopping specimen carriers (5) entering the entry port (21).

16. A cadence deviator according to one of the claims 13-15, wherein the entry port (21) comprises a beak (31, 33) for pushing the specimen carriers (5) to a slot (13) in the deviator disk (11).

17. A cadence deviator according to one of the claims 13-16, comprising a ramp (32) for elevating the specimen carrier (5) when pushed in the slot (13).

18. A cadence deviator according to the claim 17, wherein the ramp (32) is formed on the edge of the outer perimeter of the deviator disc (11).

19. A cadence deviator according to one of the claims 13-18, wherein the entry port (21) comprises an upper and lower nose (27, 28), the upper and lower nose (27, 28) being distanced from each other and located on a same axle support (29), each having a beak (31, 33), of which the beak (33) of the lower nose (28) extends further than that of the upper nose (27).

20. A cadence deviator according to one of the claims 13-19, wherein the detector (40, 41, 42) is one of the following: RFID reader for reading data from the carrier (5) at each entry, detector for identifying the specimen carrier before arrival of the specimen carrier to the entry reading 2D barcode at specimen carrier bottom, color or stored data of the order of the specimen carriers by system software when carriers are identified away from the deviator.

21. A cadence deviator according to one of the claims 13-20, wherein the deviator disc (11) comprises several slots (13).

22. A cadence deviator according to one of the claims 13-11, wherein the deviator disc (11) comprises at least one more slot (13) than the sum of the entries (15, 16, 17) and exits (18, 19, 20) to the deviator disc (11).

23. A cadence deviator according to one of the claims 13-22, wherein the actuator is configured to provide the rotation of the deviator disc at continuous, preferably at constant speed of motion.

24. A cadence deviator according to one of the claims 13-23, wherein the actuator is configured to selectively provide rotation to either direction.
